(19) United States
(12) Patent Application Publication
(10) Pub. No.: US 2013/0158735 A1
(43) Pub. Date: Jun. 20, 2013

(54) METHOD FOR SWITCHING TO A MORE FAVORABLE CONSUMPTION TARIFF FOR A DOMESTIC APPLIANCE, AND DOMESTIC APPLIANCE SUITABLE FOR SAID METHOD

(71) Applicants: Claudia Häpp, Munchen (DE); Jürgen Riesmeyer, Penzberg (DE)

(72) Inventors: Claudia Häpp, Munchen (DE); Jürgen Riesmeyer, Penzberg (DE)

(73) Assignee: BSH BOSCH UND SIEMENS HAUSGERÄTE GMBH, Munich (DE)

(21) Appl. No.: 13/817,830

(22) PCT Filed: Aug. 17, 2011
(86) PCT No.: PCT/EP2011/064151

§ 371 Date: Feb. 20, 2013

(30) Foreign Application Priority Data
Sep. 6, 2010 (DE) 10 2010 040 296.6

(51) Int. Cl. G06F 1/26

(52) U.S. Cl. CPC G06F 1/26
USPC 700/295

(57) ABSTRACT

A method and a switching device for selectively operating a domestic appliance on a public mains grid of a public utility company and a decentralized mains grid associated with the building in which the at least one domestic appliance is operated. The decentralized mains grid can feed power to the public mains grid at a feed tariff. The domestic appliance is powered either from the public mains grid or from the decentralized mains grid depending on a comparison between the tariff from the public mains grid with the feed tariff, wherein the mains grid having a sustained lower consumption tariff than the other mains grid is selected. A domestic appliance having the switching device for selectively connection to a public mains grid and to a decentralized mains grid is also disclosed.

The invention relates to a method for operating at least one domestic appliance on optionally one of at least two electric mains grids, with information relating to the consumption tariff being associated with every mains grid, the at least one first mains grid being a public mains grid of a public utility company using smart metering with currently available tariff information and the at least second mains grid being a decentralized mains grid, associated with the building within which the at least one domestic appliance is operated, the at least one decentralized mains grid being capable of feeding power into the at least one public mains grid at a feed-in tariff.

The invention also relates to a domestic appliance having a power connection to a public mains grid and a decentralized mains grid, switchgear being provided, which allows operation on optionally one of the cited mains grids.

The invention is based on the fact that more and more residential buildings or houses are being equipped with their own, in other words decentralized, power generation systems and therefore also generate electric energy. This can be for example a photovoltaic system or a biogas system, having an internal combustion engine, which drives an electric generator. With the latter system the waste heat from the internal combustion engine is also generally used to heat the house. The term heat-power coupling is then generally used.

Because of the statutorily regulated feed-in payment it is more economical for operators or users of such—decentralized-systems to feed the electric energy generated with their own system into the public mains grid and not to use it themselves in the house it belongs to. This is because at present the payment per unit of energy, e.g. kWh, for feeding into the public mains grid is higher than the cost of drawing the same unit of energy, e.g. kWh, from the public mains grid.

However this situation will change in the future. It can be assumed that the feed-in payment will drop. For operators of privately owned power generation systems of the type described above it is then more economical to use the energy generated with such a system themselves and not to feed this energy or power into the public grid.

The public utility companies with their associated public mains grids are required, as from the beginning of 2011, to offer flexible, time-based or load-variable power tariffs or tariffs for drawn electric energy. The price of a unit of energy, e.g. kWh, will then lie both above and below current prices (in Germany currently 0.21 euros per kWh on average) and will change to a greater degree as a function of numerous factors than was the case before.

For the operators or users of the decentralized systems described above it then becomes difficult to decide, in such a situation, whether they should feed the electric energy they generate into the public grid or whether they should draw electric energy from the public grid, if they intend to operate at least one domestic appliance.

It is also part of the prior art according to DE 10 2008 062 349 A1 that domestic appliances, such as washing machines, dryers or dishwashers, which are connected to a public mains grid that clearly complies with the new statutory conditions taking into account different tariffs, which are also used as the basis for consumption metering, by analyzing tariff information, which is provided by way of the public mains grid, are operated at times when power drawing costs are lower according to the tariff information. However this does not take into account the problem that results with the availability of a further grid with a decentralized power generation system in addition to the public mains grid.

The object of the invention is therefore to specify a method which automatically brings about a suitable supply of electric energy to at least one domestic appliance when there are at least two electric mains grids available.

A further object of the invention is to specify how the at least one domestic appliance is to be designed in order automatically to bring about the supply of electric energy to the at least one domestic appliance when there are at least two electric mains grids available.

This object is achieved for the method described in the introduction in that the selection of the electric mains grid able to supply power to the at least one domestic appliance is effected by comparing information about the tariff of the public mains grid with the feed-in payment and in that the grid for supplying power is selected, which has a sustainably lower consumption tariff than the other grid.

This largely ensures that at least one domestic appliance of a household can be operated in a favorable manner in respect of consumption.

According to one development of the method it is advantageous for the tariff information of both the public mains grid and the feed-in tariff to be analyzed and for the switch from one grid to the other grid only to take place, if the information comparison over a certain integration period shows that one of the grids has information about a more favorable tariff than the other grid.

The inventive design of the domestic appliance means that it has switchgear, which has:

an electrical connection to both the public mains grid and the decentralized mains grid,

a changeover switch, which in a first switching position a brings about the connection to the public mains grid and in a second switching position b brings about the connection to the decentralized mains grid, and

an electronic controller having a power switching stage for actuating an electromagnetic linear drive (20) for switching the changeover switch from the first switching position a to the second switching position b, if the analysis of tariff information from the public mains grid compared with a feed-in tariff for feeding power from the decentralized mains grid into the public mains grid indicates that the tariff of the public mains grid is higher than the feed-in tariff for feeding power from the decentralized mains grid into the public mains grid.

The switchgear described can be added to the at least one conventional domestic appliance as an auxiliary device or as separately structured switchgear. The original appliance connector of the conventional domestic appliance is then connected to the switchgear output. If the switchgear is integrated in a domestic appliance embodied in the novel manner, a direct connection is established from the switchgear to the original power connector of the domestic appliance within the housing of the domestic appliance. In both instances it is largely ensured that the domestic appliance can be operated in a manner that is extremely favorable in respect of consumption, particularly as the user does not have to worry about selecting the appropriate mains grid in each instance.

It is also within the scope of the invention to operate a number of domestic appliances of an economic unit, for example a household, on the separately structured switchgear. It is also within the scope of the invention not to operate the switchgear exclusively by way of tariff information obtained by way of the interface with an energy meter but also to analyze corresponding information transmitted by way of the internet using assigned devices, such as routers, gateways, etc.

Further advantages of the inventive domestic appliance will emerge from the subject matter of the claims that are dependent on the independent claim relating to a domestic appliance.

The invention is described schematically in more detail in the figures which follow based on exemplary embodiments. Identical reference characters signify identical or comparable parts. The figures are first explained briefly:

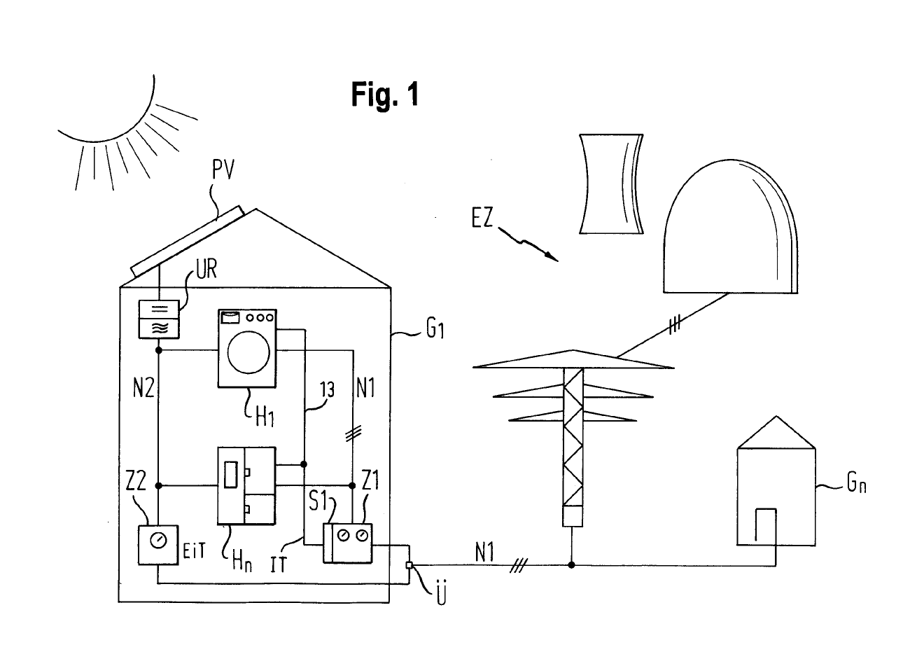

FIG. 1 shows an illustration of an overall system with a building which has a one public and one decentralized mains grid for operating at least one domestic appliance,

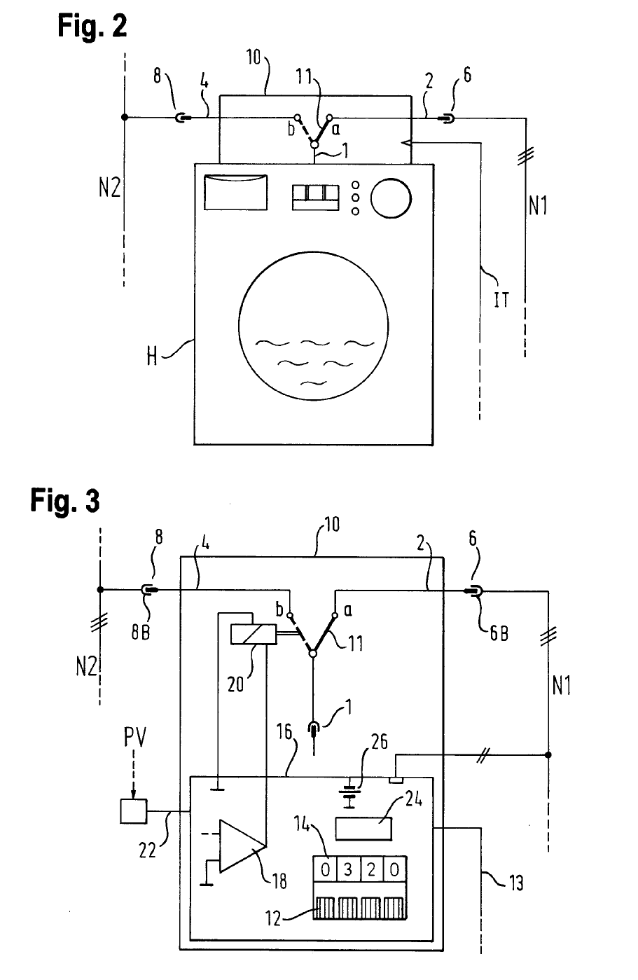

FIG. 2 shows a domestic appliance within the building from FIG. 1, which can be switched to one of the mains grids, a block diagram being added as a supplement,

FIG. 3 shows details of the switching facility of the domestic appliance from FIG. 2.

FIG. 1 first shows a schematic diagram of a power plant, which feeds in the generated electric energy by way of substations (not shown) by way of overhead lines and further substations (not shown) into a public mains grid N1 of an estate or community to supply numerous buildings. The chain for generating the electric energy until it is supplied to the public mains grid N1 is combined as EZ.

The buildings G₁ to Gₙ are generally supplied with electric energy from the cited public mains grid N1 by way of underground cables. One of the buildings, for example G₁, also has a decentralized electric energy generation system, such as a photovoltaic system PV. Instead of a photovoltaic system a decentralized electric energy generation system can also consist of a biogas system, for example if it is an agricultural building or property. The biogas generated is then used to operate an internal combustion engine with an electric generator, which then generally supplies a three-phase voltage system or rotary current directly at its output. The waste heat from the internal combustion engine can be used to heat the building. With the photovoltaic system PV direct current is generally first generated and rotary current is generated by way of a converter (with an inverter component). In both instances cited by way of example a decentralized mains grid N2 is created, which is also able to feed generated electric energy or rotary current into the public mains grid N1. The operator of the decentralized mains grid receives a feed-in payment or a payment at a feed-in tariff EiT for this.

The building G₁ is equipped with a photovoltaic system PV, which supplies a decentralized grid N2 by way of a converter UR. The decentralized grid N2 is connected at the transfer point Ü of the public mains grid N1 to the building G₁ or to a point somewhat further away from it. By controlling the converter UR, e.g. in respect of the amplitude of the voltage while adjusting the phase angle, it is possible for the decentralized grid N2 to feed electric energy generated by the photovoltaic system PV to the public grid N1 or to feed current, for example rotary current, into said network N1. This fed-in electric energy is metered with a meter Z2. The operator of the decentralized power generation system, such as the photovoltaic system PV, receives a feed-in payment EiT for each unit of energy, e.g. kWh, fed in for this.

Domestic appliances of the building G₁ receive a standard power supply by way of the public mains grid N1. The electric energy consumed is captured using a meter Z1. As the underlying public mains grid N1 is already configured as a grid with smart power metering, the electric energy consumed is captured according to changing tariffs. Information IT about the current energy tariff is forwarded by way of the grid N1 by way of a particular transmission method, for example Powerline, to buildings, such as G₁, and is generally available at an interface S1 of the energy meter, such as Z1 here. The information IT about the current tariff of the public mains grid N1 can be forwarded to the domestic appliances H₁ to Hₙ.

In the present relevant sense the decentralized grid N2 is also available in the building G₁ to supply energy to domestic appliances H₁ to Hₙ. Such domestic appliances may be washing machines, washer-dryers, refrigerators, freezers and the like.

We will now look in more detail at a development of a domestic appliance H, for example H₁, in the building G, for example G₁. Reference is made essentially to FIG. 2 for this purpose. The domestic appliance H is shown by way of example as a washing machine. The actual appliance connector for the electric energy to be supplied or the power connector is divided into two connectors 2 and 4, which are intended to replace the actual power connector 1, which can no longer be used for the connection to a mains grid. The actual, original power connector 1 should however continue to be used as an internal power connector of the domestic appliance H.

Switchgear 10 is provided, which is configured as switchgear added to the domestic appliance H or switchgear integrated in the domestic appliance H. For greater clarity the switchgear 10 is shown as a device 10 added to or positioned on the domestic appliance H. Present in the device is a changeover switch 11 (shown schematically) with two switching positions a and b. In switching position a the connector 2 is connected to the actual connector 1. In switching position b the connector 4 is connected to the actual power connector 1. The public mains grid N1 is connected to the power connector 2. The decentralized mains grid N2 is connected to the power connector 4. Plugs 6 and 9 can also be provided for this purpose, being plugged into sockets 6B and 8B.

The switchgear 10 also receives tariff information IT from the public grid N1, preferably forwarded from the interface S of the meter Z1 by way of an information line 13. The feed-in payment or feed-in tariff EiT is known and is supplied for reading or analysis by way of an electronic controller 16 by the switchgear 10 as a data record, which can be input for example by way of a keyboard 12 or thumbwheels as setting elements with a display 14. Within the switchgear 10 the tariff information IT from the public grid N1 is routed by way of the information line 13 to the controller 16. According to the invention the controller 16 is also structured so that it can compare the tariff information IT from the public grid N1 with the feed-in tariff EiT. The changeover switch 11 can be moved to position a or b by means of an electromagnetically actuated linear drive 20 by way of a power switching stage 18 of the electronic controller 16. If the controller 16 now identifies that the currently available tariff of the public mains grid N1 is lower than the feed-in tariff EiT based on the analysis of the tariff information IT, the changeover switch 11 is moved to switching position a by way of the switching stage 18. The domestic appliance H obtains electric energy solely by way of the public mains grid N1. However if it is identified that the available tariff IT of the public mains grid N1 exceeds the feed-in payment, in other words IT is greater than EiT, the changeover switch 11 is moved to switching position b by the switching stage 18 and the linear drive 20. The domestic appliance obtains electric energy solely by way of the decentralized grid N2, in other words the energy generated by the decentralized power generation system, for example the photovoltaic system PV.

It goes without saying that the possibility of switching using the switchgear 10 from the public mains grid N1 to the decentralized mains grid 2 has its limitations if the decentralized power generation system fails temporarily or for a longer period. For this purpose the switchgear 10 or its controller 16 has further inputs, for example 22, which provide information about the ability of the decentralized power generation system PV to generate electric energy, which would amount to a momentary feed into the public mains grid N1. Also just the availability of voltage at the connector 4 can also be monitored in a simplified form. If as a result of these monitored variables, the decentralized grid N2 is therefore not able to supply energy, the changeover switch 11 is switched to switching position a. In such an instance the tariff information IT from the public mains grid can still be analyzed for domestic appliances which are suitable or designed for the periodic switching off of electric energy and the domestic appliance is only operated when a low consumption tariff is available.

The switchgear 10 or its controller 16 can also be developed in different ways. For example provision can be made for too short a switch from the tariffs IT of the public mains grid to the feed-in payment or the feed-in tariff to be suppressed, in other words there can be no immediate switching with the changeover switch 11, to ensure the useful life of the contacts of the changeover switch and reduce any noise occurring during switching. Instead of or in addition to the described suppression of switching, the information about the tariffs IT of the public mains grid N1 can be monitored by way of a computation model in order to reach a decision on switching with the changeover switch 11 taking into account the results of monitoring using the computation model 24, which can be considered to be sustainable. It may also be possible to buffer the voltage supply to the controller by way of a battery or supercapacitor 26, in order to ensure the reliable function of the controller 16 if a mains grid fails and the failed grid then has to be brought back into operation.

### LIST OF REFERENCE CHARACTERS

N1 Public mains grid
N2 Decentralized mains grid
EZ Power generation chain public mains grid
PV Decentralized power generation system, photovoltaic
UR Converter
EiT Feed-in tariff
IT Tariff, current of public mains grid
Ü Transfer point for feeding into public mains grid
Z1 Power meter for public mains grid
S1 Interface to Z1
Z2 Power meter for feeding into public mains grid
G_{1 . . . n} Building with supply from public mains grid
H_{1 . . . n} Domestic appliances in building
1 Power connector, original of H
2 Power connector to grid N1
4 Power connector to grid N2
6 Plug for N1
6A Socket for N1
8 Plug for N2
8A Socket for N2
10 Switchgear
11 Changeover switch
a Switching position of 11 (grid N1)
b Switching position of 11 (grid N2)
12 Setting of EiT
13 Information line for IT
14 Display of set EiT value
16 Electronic controller
18 Power switching stage
20 Electromagnetically actuated linear drive
22 Input for signal that decentralized power generation system able to supply
24 Computation model for monitoring tariff IT
26 Battery or supercapacitor for buffering voltage supply for 16

1-9. (canceled)

10. A method for operating at least one domestic appliance on an electric grid selected from at least two electric mains grids, wherein each mains grid comprises information relating to a consumption tariff being associated with the respective mains grid, wherein a first of the at least two mains grids is a public mains grid of a public utility company using smart metering with currently available tariff information and a second of the at least two mains grids is a decentralized mains grid associated with a building in which the at least one domestic appliance is operated, wherein the second mains grid is configured to feed electric power into the at least one public mains grid at a feed-in tariff, the method comprising the steps of:
comparing the currently available tariff information with the feed-in tariff, and
selecting a mains grid for supplying power to the at least one domestic appliance from the first and second mains grids based whether the first mains grid or the second mains grid has a sustainably lower consumption tariff.

11. The method of claim 10, further comprising the steps of:
analyzing the information relating to the consumption tariffs,
comparing the information relating to the consumption tariffs over a predetermined integration period, and
switching from the first mains grid to the second mains grid, or vice versa, only when the comparison shows that one of the first or second mains grids has a more favorable tariff than the other of the second or first main grids.

12. A domestic appliance having a power connection to a public mains grid and to a decentralized mains grid, the domestic appliance comprising a switching device including:
an electrical connection to both the public mains grid and the decentralized mains grid,
a changeover switch, which in a first switching position establishes a connection to the public mains grid and in a second switching position establishes a connection to the decentralized mains grid, and
an electronic controller having a power switching stage for actuating an electromagnetic linear drive for switching the changeover switch from the first switching position to the second switching position when an analysis of tariff information from the public mains grid compared with a feed-in tariff for feeding power from the decentralized mains grid into the public mains grid indicates that the tariff of the public mains grid is higher than the feed-in tariff for feeding power from the decentralized mains grid into the public mains grid.

13. The domestic appliance of claim 12, wherein the electronic controller initiates switching of the changeover switch from the second switching position to the first switching position when the analysis of tariff information from the public mains grid compared with the feed-in tariff for feeding power from the decentralized mains grid into the public mains grid indicates that the tariff of the public mains grid is lower than the feed-in tariff for feeding power from the decentralized mains grid into the public mains grid.

14. The domestic appliance of claim 12, wherein the electronic controller actuates the changeover switch only when the analysis of tariff information from the public mains grid compared with the feed-in tariff for feeding power from the decentralized mains grid into the public mains grid indicates that a difference between the tariff of the public mains grid and the feed-in tariff causing the changeover will be sustained over an extended integration time.

15. The domestic appliance of claim 12, wherein the electronic controller actuates the changeover switch only when the analysis of tariff information from the public mains grid compared with the feed-in tariff for feeding power from the decentralized mains grid into the public mains grid indicates that the result of the comparison is supported by the monitoring of the tariff information from the public mains grid with a computer model.

16. The domestic appliance of claim 12, wherein the electronic controller initiates switching of the changeover switch to the first switching position when the decentralized power supply fails to supply electric power.

17. The domestic appliance of claim 12, further comprising a battery or a supercapacitor buffering a voltage supply to the electronic controller.

18. A switching device gear having an electrical connection to both a public mains grid and a decentralized mains grid, comprising:
a changeover switch, which in a first switching position establishes a connection to the public mains grid and in a second switching position establishes a connection to the decentralized mains grid, and
an electronic controller having a power switching stage for actuating an electromagnetic linear drive for switching the changeover switch from the first switching position to the second switching position, when an analysis of tariff information from the public mains grid compared with a feed-in tariff for feeding power from the decentralized mains grid into the public mains grid indicates that the tariff of the public mains grid is higher than the feed-in tariff for feeding power from the decentralized mains grid into the public mains grid,
said switching device being configured as a stand-alone switching device capable of switching at least one domestic appliance of a household from the public mains grid to the decentralized mains grid or from the decentralized mains grid to the public mains grid.
